(19) United States
(12) Patent Application Publication
(10) Pub. No.: US 2012/0233141 A1
(43) Pub. Date: Sep. 13, 2012

(54) APPARATUS, METHOD AND COMPUTER-READABLE STORAGE MEDIUM FOR SEARCHING PATIENT STUDIES

(75) Inventor: Stephen Lambie, North Vancouver (CA)

(73) Assignee: McKesson Financial Holdings

(21) Appl. No.: 13/044,164

(22) Filed: Mar. 9, 2011

(51) Int. Cl. G06F 17/30

(52) U.S. Cl. 707/706; 707/E17.108

(57) ABSTRACT

An apparatus is provided that includes a processor and memory storing executable instructions that in response to execution by the processor cause the apparatus to at least perform a number of operations. The apparatus is caused to query a search engine index based upon a user query including a search term, and based upon one or more synonyms of the term. The search engine index is of a database of unstructured, free-text reports, and the search engine index is queried to locate identifiers of image studies associated with reports including the search term or synonym(s). The apparatus may be caused to sort or filter the search results based on patient information from the image studies of the located identifiers, receive user selection of one or more image studies from the search results, and retrieve the selected one or more image studies.

### FIELD OF THE INVENTION

The present invention generally relates to medical studies of patients, and more particularly, to searching a database of patient studies.

### BACKGROUND OF THE INVENTION

Medical imaging often includes creating images of the human body or parts of the human body for clinical purposes such as examination, diagnosis and/or treatment. These images may be acquired by a number of different imaging modalities including, for example, ultrasound (US), magnetic resonance (MR), positron emission tomography (PET), computed tomography (CT), mammograms (MG) digital radiology (DR), computed radiology (CR) or the like. In a number of example medical imaging workflows, such as in the case of a picture archiving and communication system (PACS), an image study for a patient may include one or more acquired images of the patient along with information that may reside with or otherwise accompany the images. This information may include, for example, a study identifier (ID) as well as patient information such as the patient's name, demographics, medical record number or the like.

Once a patient study has been created, the study may be stored in a database of a central storage device for later retrieval by a workstation where the study may be reviewed by a medical professional such as a radiologist who may make one or more diagnoses or other assessments of the patient from the study, and record those diagnoses or other assessments in a text-based report. This report may then be stored in an information system such as a hospital information system (HIS), radiology information system (RIS) or the like, where the report may be linked or otherwise associated with the image study such as by study ID, patient name, medical record number or the like.

In various instances, it may be desirable to locate relevant patient studies that exemplify or demonstrate a particular medical condition or state. In these instances, a condition or state may be embodied by a text description, such as “fracture,” “pneumonia” or the like. This information may not be stored in the study itself, but in the text-based report associated with the study. It may be inconvenient to search the database that holds these reports since the size of the database (millions of records) and the subsequent load on the database may make the search slow and impact other users of the database (hundreds of users). The text-based reports associated with the studies may be unstructured, free-text reports, which may further complicate their being searched. And as additional disadvantage, there may be variance in language used to describe the same diagnosis or finding.

### SUMMARY OF THE INVENTION

In light of the foregoing background, exemplary embodiments of the present invention provide an apparatus, method and computer-readable storage medium for searching a database of patient studies. According to one aspect of exemplary embodiments of the present invention, an apparatus is provided that includes a processor and a memory storing executable instructions that in response to execution by the processor cause the apparatus to at least perform a number of operations. In this regard, the apparatus is caused to receive a user query including a search term, and retrieve one or more synonyms of the search term.

The apparatus is also caused to query a search engine index based upon the user query and one or more synonyms, where the search engine index is of a database of unstructured, free-text reports. For each report, the index includes an identifier of an image study associated with the respective report, and each image study is for a patient and includes respective patient information. In this regard, the search engine index is queried to locate reports including any of the search term or one or more synonyms to thereby locate the identifiers of image studies associated with the respective located reports.

The apparatus is caused to present to the user search results including the identifiers of image studies associated with the respective located reports, and including the patient information from the respective image studies. Further, the apparatus is caused to sort or filter the search results based on the patient information to facilitate the user locating one or more image studies from the search results. And the apparatus is caused to receive user selection of one or more image studies from the search results, and retrieve the selected one or more image studies.

In various instances, for each report the index may further include attributes of the respective report, such as one or more of a status, classification or priority of the respective report. In such instances, the apparatus being caused to receive a user query may include being caused to receive a user query including a search term and one or more attributes.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system configured to operate in accordance with exemplary embodiments of the present invention;

FIG. 2 is a schematic block diagram of an apparatus that may be configured to operate as or otherwise perform one or more functions of one or more of the components of the system of FIG. 1, in accordance with embodiments of the present invention;

FIG. 3 is a functional block diagram of the system of FIG. 1, including further functional elements of various ones of the components of the system, according to an example embodiment of the present invention; and

FIG. 4 is a flowchart illustrating various operations in a method according to exemplary embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Further, the apparatus and method of example embodiments of the present invention will be primarily described in conjunction with medical-imaging applications. It should be understood, however, that the apparatus and method can be utilized in conjunction with a variety of other applications, both in the medical industry and outside of the medical industry. Like numbers refer to like elements throughout.

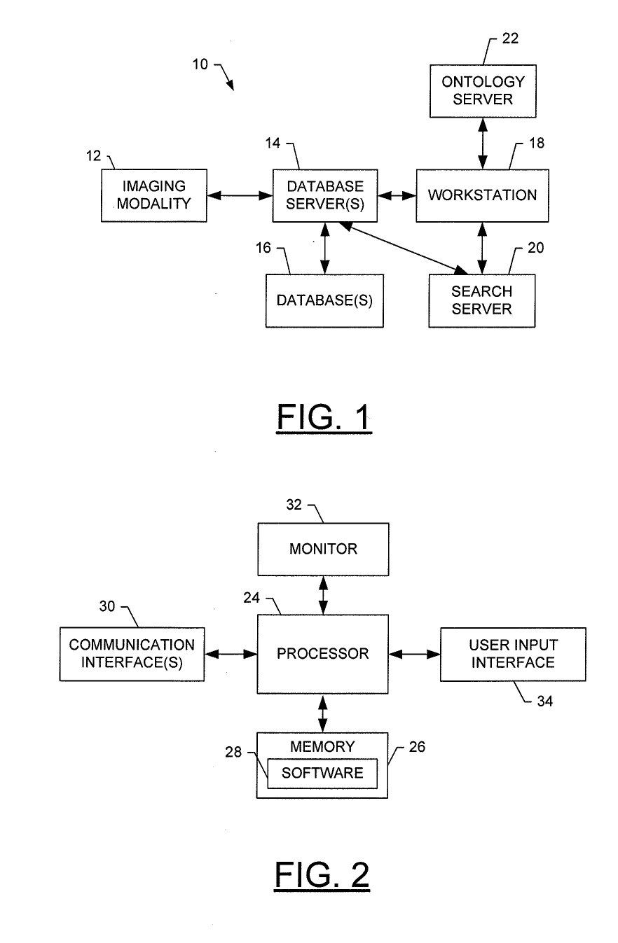

FIG. 1 illustrates a system 10 that may benefit from exemplary embodiments of the present invention (“exemplary” as used herein referring to “serving as an example, instance or illustration”). As shown, the system includes one or more imaging modalities 12 for acquiring an image, such as an image of the human body or parts of the human body for clinical purposes such as examination, diagnosis and/or treatment. Examples of suitable modalities include, for example, ultrasound (US), magnetic resonance (MR), positron emission tomography (PET), computed tomography (CT), mammograms (MG) digital radiology (DR), computed radiology (CR) or the like. The system 10 may also include one or more database servers 14 configured to receive image studies from the modalities 12 and other patient information such as patient text-based reports (e.g., unstructured, free-text reports), and archive the images and information in one or more databases 16 or other central storage devices. In one example embodiment, the database server(s) and database(s) may form part of one or more of a hospital information system (HIS), radiology information system (RIS), picture archiving and communication system (PACS) or the like. The database server(s) may therefore include a HIS server, RIS server, PACS server or the like, each of which is configured to interface with a respective database. In other example embodiments, the database server(s) may include a database server configured to support multiple ones of a HIS, RIS and/or PACS server, logically separated but co-located within the respective server.

The system may include one or more workstations 18 configured to receive patient image studies from the database server 14, and present the studies such as for review by a medical professional such as a radiologist. The review may include, for example, a medical professional reviewing a study to make one or more diagnoses or other assessments of the patient from the study, which may be recorded in a text-based report. This report may may be an unstructured, free-text report that may have an associated identifier (ID). The report may then be stored in a database 16b, where the report may be linked or otherwise associated with the image study such as by study ID, patient name, medical record number or the like. Similar to the database server(s), the workstation(s) may be workstation(s) of one or more of a HIS, RIS, PACS or the like. The workstation(s) may therefore include a HIS workstation, RIS workstation, PACS workstation or the like, each of which is configured to interface with a respective database server 14 and database 16. In other example embodiments, the workstation(s) may include a workstation configured to support multiple ones of a HIS, RIS and/or PACS workstation, logically separated but co-located within the respective workstation.

The system may further include one or more servers providing one or more additional services to the database server 14 and/or workstation 18. As shown, for example, these servers may include a search server 20 and an ontology server 22. The search server may be configured to implement an indexer and search engine. The indexer is a tool that at one or more instances may crawl the database 16 for text-based reports and generate a separate store or search engine index of the reports that may be optimized for text searches. The index may be generated according to a configuration that specifies how to connect to the database, from where in the database to retrieve the text, which reports to retrieve and what attributes to store against each report. An attribute may include the ID of the associated patient image study, and may also include other report attributes such as, for example, status (e.g., preliminary, final), classification (e.g., normal, significant), priority (e.g., low, normal, high) or the like. Any useful attribute may be used to filter search results down to interesting sets.

The search engine functionality of the search server 20 may provide an interface to the index. The search engine may be configured to receive a search query, perform a search of the index and return a search result based on the search. One example of a suitable search server that may implement both indexer and search engine functionality is the Sphinx open source search server developed by Sphinx Technologies Inc.

In practice, the patient text-based reports associated with image studies may use different terminology to refer to the same concepts. The ontology server 22 may therefore be configured to receive a term and return one or more synonyms of the term, in instances in which the term has one or more synonyms. The term and its synonyms may be provided to the search server 20 for use in indexing the text-based reports, and/or for use in searching the index of reports. In either instance, by interaction with the ontology server, a more complete search result may be provided by accounting for not only search terms but their synonyms. One example ontology server is the Radlex server provided by the Radiological Society of North America (RSNA).

The imaging modality 12, database server 14, database 16, workstation 18, search server 20 and/or ontology server 22 may be configured to directly and/or indirectly communicate with one another in any of a number of different manners including, for example, any of a number of wireline or wireless communication or networking techniques. Examples of such techniques include, without limitation, Universal Serial Bus (USB), radio frequency (RF), Bluetooth (BT), infrared (IrDA), any of a number of different cellular (wireless) communication techniques such as any of a number of 2 G, 2.5 G, 3 G or 4 G communication techniques, local area network (LAN), wireless LAN (WLAN) techniques or the like. In accordance with various ones of these techniques, the imaging modality, database server, database, workstation, search server and/or ontology server may be coupled to and configured to communicate across one or more networks. The network(s) may include any of a number of different combinations of one or more different types of networks, including data and/or voice networks. For example, the network(s) may include one or more data networks, such as a LAN, a metropolitan area network (MAN), and/or a wide area network (WAN) (e.g., Internet), and include one or more voice networks, such as a public-switched telephone network (PSTN). Although not shown, the network(s) may include one or more apparatuses such as one or more routers, switches or the like for relaying data, information or the like between the imaging modality, database server, database, workstation, search server and/or ontology server.

Reference is now made to FIG. 2, which illustrates a block diagram of an apparatus that may be configured to operate as or otherwise perform one or more functions of an imaging modality 12, database server 14, database 16, workstation 18, search server 20 and/or ontology server 22. Although shown in FIG. 1 as separate apparatuses, in some embodiments, one or more of the respective apparatuses may support more than one of an imaging modality, database server, database, workstation, search server and/or ontology server, logically separated but co-located within the apparatus(es). For example, a single apparatus may support a logically separate, but co-located database server and database; and in the same or another example, a single apparatus may support a logically separate, but co-located database server and workstation. Even further, for example, a single apparatus may support a logically separate, but co-located database server and search server.

Generally, the apparatus of exemplary embodiments of the present invention may comprise, include or be embodied in one or more fixed electronic devices, such as one or more of a desktop computer, workstation computer, server computer or the like. Additionally or alternatively, the apparatus may comprise, include or be embodied in one or more portable electronic devices, such as one or more of a mobile telephone, portable digital assistant (PDA), tablet computer, laptop computer or the like. The apparatus of exemplary embodiments of the present invention includes various means for performing one or more functions in accordance with exemplary embodiments of the present invention, including those more particularly shown and described herein. It should be understood, however, that one or more of the apparatuses may include alternative means for performing one or more like functions, without departing from the spirit and scope of the present invention.

As shown in FIG. 2, the apparatus may include a processor 24 connected to a memory 26. The memory may include volatile and/or non-volatile memory, and typically stores content, data or the like. In this regard, the memory may store one or more software applications 28, modules, instructions or the like for the processor to perform steps associated with operation of the apparatus in accordance with embodiments of the present invention. The memory may also store content transmitted from, and/or received by, the apparatus. As described herein, the software application(s) may each comprise software operated by the apparatus. It should be understood, however, that any one or more of the software applications described herein may alternatively be implemented by firmware, hardware or any combination of software, firmware and/or hardware, without departing from the spirit and scope of the present invention.

In addition to the memory 26, the processor 24 may also be connected to at least one interface or other means for displaying, transmitting and/or receiving data, content or the like, such as in accordance with USB, RF, BT, IrDA, WLAN, LAN, MAN, WAN (e.g., Internet), PSTN techniques or the like. In this regard, the interface(s) may include at least one communication interface 30 or other means for transmitting and/or receiving data, content or the like. In addition to the communication interface(s), the interface(s) may also include at least one user interface that may include one or more earphones and/or speakers, a display 32, and/or a user input interface 34. The user input interface, in turn, may include any of a number of devices allowing the apparatus to receive data from a user, such as a microphone, a keypad, a touch-sensitive surface (integral or separate from the display), a joystick, or other input device.

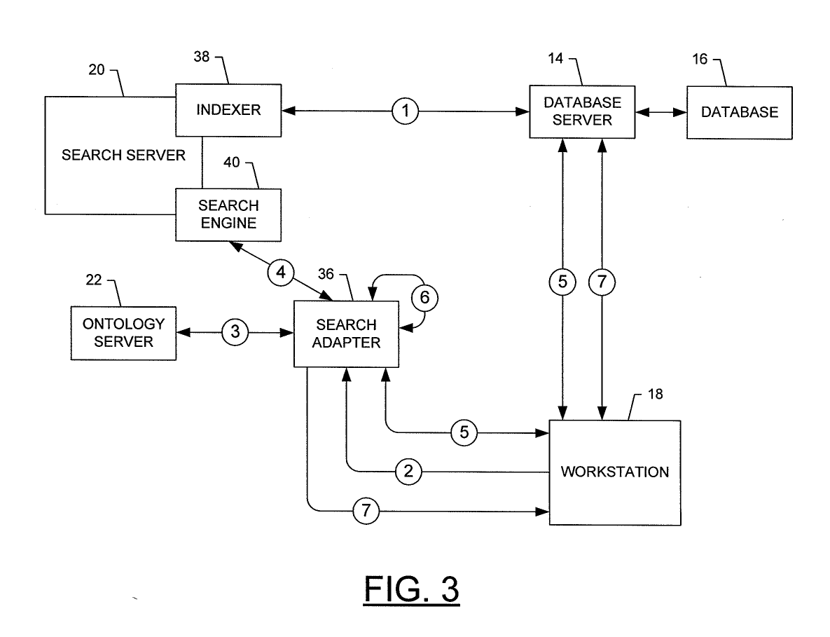

FIG. 3 illustrates a functional block diagram of the system of FIG. 1, including interaction between components of the system, according to on example embodiment of the present invention. As shown, the workstation 18 may functionally include a search adapter 36, and the search server 20 may include an indexer 38 and search engine 40. These functional components may be implemented in any of a number of different manners. In one example, the functional components may be implemented in hardware (e.g., processor 24), alone under direction of software (e.g., software 28), firmware or the like.

As shown at operation 1, the indexer 38 of the search server 20 may interact with the database server 14 and its database 16 and generate a separate store or index of the reports that may be optimized for text searches. As indicated above, the index may store one or more attributes against each report including, for example, a study ID, status, classification, priority or the like. As or after the indexer generates the index, a workstation 18 may receive a user query that includes at least one search term, and that may also include one or more of the attributes of reports being sought by the user. The user query may be passed to the search adapter 36 of the workstation, as shown at operation 2.

Upon receipt of the user query including a search term and any report attributes, the search adapter 36 may query the ontology server 22 for one or more synonyms of the search term, as shown at operation 3. The search adapter may pass the user query along with any synonyms of its search term to the search engine 40 of the search server 20. Then, at operation 4, the search engine may query the index generated by the indexer 38 to locate any text-based reports including the search term/synonyms and having the report attributes, or more particularly, to locate the study IDs of any image studies associated with text-based reports including the search term/synonyms and having the report attributes. As shown at operation 5, the search adapter may then query the database server 14 for information regarding the image studies having the located IDs. This information may include, for example, patient information such as the patient's name, demographics, medical record number or the like.

The search adapter 36 of the workstation 18 may provide the user with search results including the located study IDs and patient information, as shown at operation 6. The user may then filter or otherwise sort the search results based on the patient information to locate one or more studies from the search results. Then, at operation 7, the search adapter may receive user selection of one or more of the studies from the search results, and may query the database server 14 to retrieve the respective studies. The database server may provide the selected studies to the workstation, which may present the studies to the user.

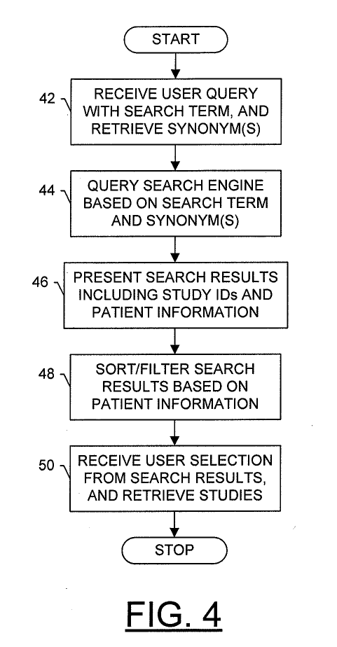

Reference is now made to FIG. 4, which illustrates various operations in a method according to one example embodiment of the present invention, the operations of which in one example may be performed by the search adapter 36. As shown in block 42, the method may include receiving a user query including a search term, and retrieving one or more synonyms of the search term. As shown in block 44, the method may include querying a search engine index based upon the user query and one or more synonyms, where the search engine index is of a database of text-based reports. In this regard, each report includes an identifier of an image study associated with the respective text-based report, and each image study is for a patient and includes respective patient information. The search engine index may therefore be queried to locate text-based reports including any of the search term or one or more synonyms to thereby locate the identifiers of image studies associated with the respective located text-based reports.

As shown in block 46, the method may also include presenting to the user search results including the identifiers of image studies associated with the respective located text-based reports, and including the patient information from the respective image studies. The method may then include sorting or filtering the search results based on the patient information to facilitate the user locating one or more image studies from the search results, as shown in block 48. The method may further include receiving user election of one or more image studies from the search results, and retrieving the selected one or more image studies, as shown in block 50.

According to one aspect of the present invention, all or a portion of the imaging modality 12, database server 14, database 16, workstation 18, search server 20 and/or ontology server 22 of exemplary embodiments of the present invention, generally operate under control of a computer program. The computer program for performing the methods of exemplary embodiments of the present invention may include one or more computer-readable program code portions, such as a series of computer instructions, embodied or otherwise stored in a computer-readable storage medium, such as the non-volatile storage medium.

FIG. 4 is a flowchart reflecting methods, systems and computer programs according to exemplary embodiments of the present invention. It will be understood that each block or step of the flowchart, and combinations of blocks in the flowchart, may be implemented by various means, such as hardware, firmware, and/or software including one or more computer program instructions. As will be appreciated, any such computer program instructions may be loaded onto a computer or other programmable apparatus to produce a machine, such that the instructions which execute on the computer or other programmable apparatus (e.g., hardware) create means for implementing the functions specified in the block(s) or step(s) of the flowchart. These computer program instructions may also be stored in a computer-readable memory that may direct a computer or other programmable apparatus to function in a particular manner, such that the instructions stored in the computer-readable memory produce an article of manufacture including instruction means which implement the function specified in the block(s) or step(s) of the flowchart. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the block(s) or step(s) of the flowchart.

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, may be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. It should therefore be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising a processor and a memory storing executable instructions that in response to execution by the processor cause the apparatus to at least:
receive a user query including a search term;
retrieve one or more synonyms of the search term;
query a search engine index based upon the user query and one or more synonyms, the search engine index being of a database of unstructured, free-text reports, wherein for each report the index includes an identifier of an image study associated with the respective report, and each image study is for a patient and includes respective patient information, and wherein the search engine index is queried to locate reports including any of the search term or one or more synonyms to thereby locate the identifiers of image studies associated with the respective located reports;
present to the user search results including the identifiers of image studies associated with the respective located reports, and including the patient information from the respective image studies;
sort or filter the search results based on the patient information to facilitate the user locating one or more image studies from the search results;
receive user selection of one or more image studies from the search results; and
retrieve the selected one or more image studies.

2. The apparatus of claim 1, wherein for each report the index further includes attributes of the respective report, and
wherein the apparatus being caused to receive a user query includes being caused to receive a user query including a search term and one or more attributes.

3. The apparatus of claim 2, wherein for each report the attributes include one or more of a status, classification or priority of the respective report.

4. A method comprising:
receiving a user query including a search term;
retrieving one or more synonyms of the search term;
querying a search engine index based upon the user query and one or more synonyms, the search engine index being of a database of unstructured, free-text reports, wherein for each report the index includes an identifier of an image study associated with the respective report, and each image study is for a patient and includes respective patient information, and wherein the search engine index is queried to locate reports including any of the search term or one or more synonyms to thereby locate the identifiers of image studies associated with the respective located reports;
presenting to the user search results including the identifiers of image studies associated with the respective located reports, and including the patient information from the respective image studies;
sorting or filtering the search results based on the patient information to facilitate the user locating one or more image studies from the search results;
receiving user selection of one or more image studies from the search results; and
retrieving the selected one or more image studies,
wherein at least querying a search engine is performed by an apparatus including a processor and a memory storing executable instructions that in response to execution by the processor cause the apparatus to at least query the search engine.

5. The method of claim 4, wherein for each report the index further includes attributes of the respective report, and
wherein receiving a user query includes receiving a user query including a search term and one or more attributes.

6. The method of claim 5, wherein for each report the attributes include one or more of a status, classification or priority of the respective report.

7. A computer-readable storage medium having computer-readable program code portions stored therein that, in response to execution by a processor, cause an apparatus to at least:
receive a user query including a search term;
retrieve one or more synonyms of the search term;
query a search engine index based upon the user query and one or more synonyms, the search engine index being of a database of unstructured, free-text reports, wherein for each report the index includes an identifier of an image study associated with the respective report, and each image study is for a patient and includes respective patient information, and wherein the search engine index is queried to locate reports including any of the search term or one or more synonyms to thereby locate the identifiers of image studies associated with the respective located reports;
present to the user search results including the identifiers of image studies associated with the respective located reports, and including the patient information from the respective image studies;
sort or filter the search results based on the patient information to facilitate the user locating one or more image studies from the search results;
receive user selection of one or more image studies from the search results; and
retrieve the selected one or more image studies.

8. The computer-readable storage medium of claim 7, wherein for each report the index further includes attributes of the respective report, and
wherein the apparatus being caused to receive a user query includes being caused to receive a user query including a search term and one or more attributes.

9. The computer-readable storage medium of claim 8, wherein for each report the attributes include one or more of a status, classification or priority of the respective report.
